(19) United States
(12) Patent Application Publication
(10) Pub. No.: US 2021/0298274 A1
(43) Pub. Date: Sep. 30, 2021

(54) POULTRY FEEDER TROUGH AND COUPLER ASSEMBLY

(71) Applicant: GSI Brasil Industria e Comercio de Equipamentos Agropecuarios Ltda, Marau (BR)

(72) Inventors: Edilson SANTIN, Marau (BR); Daironi MOGNON, Marau (BR)

(21) Appl. No.: 17/215,747

(22) Filed: Mar. 29, 2021

(30) Foreign Application Priority Data
Mar. 31, 2020 (GB) 2004664.5

(51) Int. Cl. A01K 39/014; F16B 7/04

(52) U.S. Cl. CPC A01K 39/014; F16B 7/0413

(57) ABSTRACT

A trough feeder system has a plurality of troughs connected with couplers to prevent the troughs from rotating relative to each other. Each coupler has at least one sidewall stop protruding inwardly from a sidewall that limits the distance the trough can be inserted into the coupler. The coupler has a central catch generally above the sidewall stop and a pair of outward catches, wherein the central catch and one of the outward catches capture each trough at different positions along the longitudinal axis of the trough so as to prevents the trough from rotating relative to the coupler and also the adjacent trough being held by the coupler.

### CROSS-REFERENCE TO RELATED APPLICATIONS

This application claims the benefit of the filing date of U.K. Patent Application GB2004664.5, filed Mar. 31, 2020, the entire disclosure of each of which is incorporated herein by reference.

### BACKGROUND OF THE INVENTION

### Field of Invention

This disclosure relates to poultry trough feeders, and more particularly to a coupler connecting adjacent troughs of the poultry trough feeders.

### Description of Related Art

Large poultry houses have the need to provide equal access to feed for all birds in the house to promote uniform development and create a low-stress environment. One common way of distributing feed to all the birds in the poultry house is to use a trough feeder system having a belt or chain drive system for distributing the feed throughout the troughs. The trough feeder system 10 has multiple lengths of troughs coupled together that are typically either mounted on stand legs or suspended from the poultry house ceiling using a lifting system. Smaller troughs may be used for pullets and larger troughs may be used for laying hens or broilers. But no matter what size of trough is used, it is necessary that the multiple lengths of troughs be coupled together in a strong and stable manner.

Assembly of the trough feeder system can be a complex operation. Additionally, it is necessary to periodically disassemble the trough feeder system to clean and disinfect the poultry house. Disassembling and then reassembling the multiple troughs can be a time consuming and labor intensive procedure. It is desired that the assembly operation, both for initial installation and maintenance/cleaning, be as quick and easy as possible thereby decreasing installation cost and time. In order to add these features.

Therefore, it would be desirable to have an improved feeder trough and coupler assembly that enables assembly/disassembly of the trough feeders without using bolts while also not significantly increasing the component size and complexity in order to reduce cost and operation time.

### BRIEF SUMMARY OF THE INVENTION

In one aspect, the invention is directed to a trough feeder system having a plurality of troughs that are arranged end to end, each trough having a base and a pair of sidewalls extending from the base so the trough forms a cupping shape such that the trough is able to contain a supply of feed. The trough feeder system has a plurality of couplers, each of the couplers configured to connect two adjacent troughs such that each of the troughs is prevented from rotating both horizontally and vertically relative to the trough to which it is joined with the coupler. Each coupler has a base and a pair of sidewalls such that the coupler has a cupping shape substantially corresponding to the shape of the troughs, wherein an end of the trough coupled by the coupler is slidingly inserted into one end of the coupler. Each coupler has at least one sidewall stop protruding inwardly from one of the coupler sidewalls that limits the distance that the trough can be inserted longitudinally into the coupler, wherein the sidewall stop has a protruding lip that extends over a distal end of the sidewall of the inserted trough. The coupler has a lower stop protruding upwardly from the coupler base that limits distance that the trough can be inserted longitudinally into the coupler. The coupler has a plurality of upper catches protruding inwardly from at least one of the coupler sidewalls, the plurality of catches comprising a central catch generally above the sidewall stop and a pair of outward catches, one close to the each end of the coupler, wherein the central catch and one of the outward catches capture each trough at different positions along the longitudinal axis of the trough so as to prevents the trough from rotating relative to the coupler and also the adjacent trough being held by the coupler.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a perspective view of adjacent troughs and a coupler as part of the poultry trough feeder assembly of the present disclosure;

FIG. 2 is a perspective view of the coupler of the poultry trough feeder assembly of FIG. 1; and

FIG. 3 is a side view of the trough feeder assembly of FIG. 1 used in a suspended trough feeder system.

Corresponding reference characters indicate corresponding parts throughout the several views of the drawings.

### DESCRIPTION OF PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

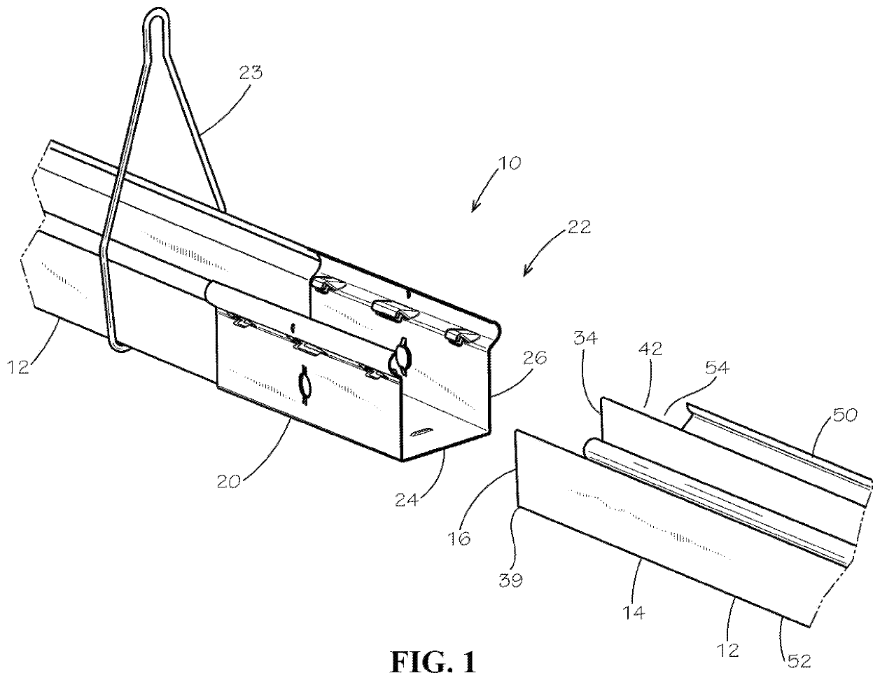

Referring initially to FIG. 1 of the drawings, a trough feeder system 10 for use within a poultry house is shown. The trough feeder system 10 has a plurality of troughs 12 that are arranged end to end within the poultry house such that feed is made available over a wide area of the poultry house. Each trough 12 has a base 14 and a pair of sidewalls 16 extending from the base 14 forming a cupping shape such that the trough 12 is able to contain a supply of feed for the poultry living in the poultry house. Adjacent troughs 12 are connected by a coupler 20 so that the troughs 12 and coupler 20 form a feeder assembly 22. The feeder assembly 22 may be suspended from the ceiling (not shown) of the poultry house with hangers 23, or may be supported on the ground with legs (not shown). As one skilled in the art will understand, the trough feeder system 10 includes a drive mechanism (not shown), such as a belt or chain drive, within the feeder assembly 22 configured to move feed throughout the trough feeder system 10. Since any suitable drive mechanism may be used, detailed description of the drive mechanism need not be included herein.

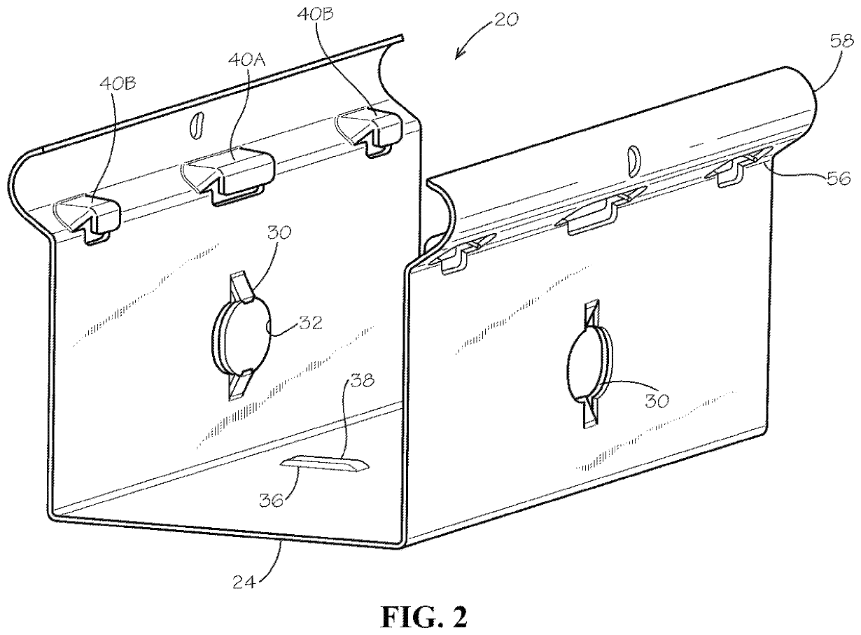

The coupler 20 holds two adjacent troughs 12 in a stable manner such that the feeder assembly 22 is structurally sound and each trough 12 is prevented from rotating both horizontally and vertically relative to the adjacent trough 12 to which it is joined with the coupler 20. Turning also now to FIG. 2, the coupler 20 has a base 24 and a pair of sidewalls 26 such that the coupler 20 has a cupping shape substantially corresponding to the shape of the trough 12. However, the coupler base 24 is slightly wider than the base 14 of the trough 12 so that each trough 12 can be slidingly inserted into one end of the coupler 20. At least one of the coupler sidewalls 26, and in the illustrated embodiment both of the sidewalls 26, has a stop 30 protruding inwardly that limits the distance that the trough 12 can be inserted longitudinally into the coupler 20. Desirably, the stop 30 has a protruding lip 32 that extends over a distal end 34 of the sidewall 16 of the trough 12. In the illustrated embodiment, the stop 30 has protruding lips 32 in both directions such that the stop 30 acts as a catch for both of the troughs 12 being joined by the coupler 20. Additionally, the coupler base 24 has a lower stop 36 protruding upwardly that limits the also distance that the trough 12 can be inserted longitudinally into the coupler 20. Desirably, the lower stop 36 has a protruding lip 38 that extends over a distal end 39 of the base 14 of the trough 12. In the illustrated embodiment, the lower stop 36 has protruding lips 38 in both directions such that the lower stop 36 acts as a catch for both of the troughs 12 being joined by the coupler 20. Desirably, the stops 30, 36 are formed by stamping during the forming of the coupler 20. However, the also may be bolted, riveted, welded, or otherwise fastened to the sidewalls 16 and base 14 of the trough 12.

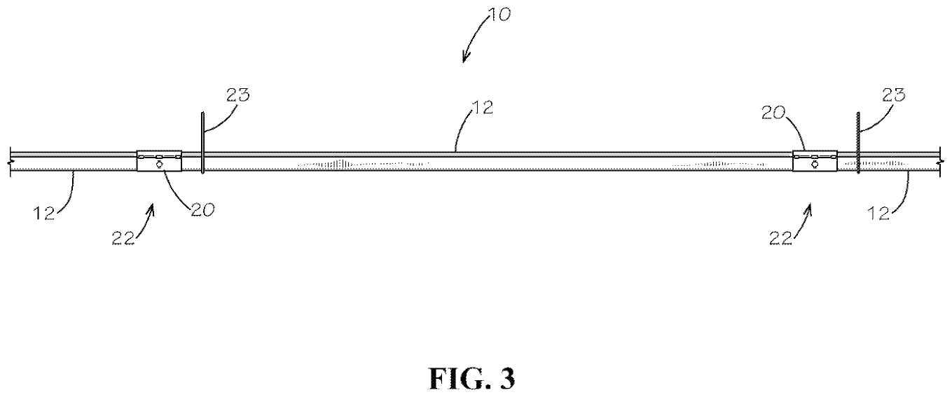

At least one of the coupler sidewalls 26, and in the illustrated embodiment both of the sidewalls 26, has a plurality of upper catches 40 protruding inwardly toward the longitudinal central axis A of the coupler 20. In the illustrated embodiment, the coupler sidewall 26 has a central catch 40A generally above the stop 30 and a pair of outward catches 40B, one close to the each end of the coupler 20. The central catch 40A is long enough such that it extends longitudinally on each side of the stop 30 such that when two troughs 12 are inserted into the coupler 20 such that distal ends 34 of the troughs 12 contact opposing sides of the stop 30, an upper edge 42 of each trough sidewall 16 is captured by the central catch 40A. However, one skilled in the art will understand that the coupler 20 may have two central catches 40A, one for each trough 12, without departing from the scope of the invention. Additionally, at a position inward from the distal end 34 of the trough sidewall 16, upper edge 42 of each trough sidewall 16 is also captured by one of the outward catches 40B. Having the central catch 40A and the outward catch 40B capture the trough 12 at different positions along the longitudinal axis A of the trough 12 prevents the trough 12 from rotating relative to the coupler 20 and also the adjacent trough 12 being held by the coupler 20. Desirably, the catches 40A, 40B are formed by stamping during the forming of the coupler 20. However, the also may be bolted, riveted, welded, or otherwise fastened to the sidewalls 16 of the coupler 20. Desirably, each sidewall 26 of the coupler 20 has the central catch 40A and outward catches 40B to provide robust capture of the troughs 12 with the coupler 20. With the feeder assembly 22 properly joined together, a hanger 23 attached to one of the troughs 12 is able to vertically the entire feeder assembly 22 as seen in FIG. 3.

In one embodiment, upper edges 42 of the trough sidewall 16 have an anti-spill lip 50 at least partially along the longitudinal length of the trough 12. Desirably, the anti-spill lip 50 is formed on the upper edge 42 of the trough sidewall 16 in a middle portion 52 of the trough 12 but a distal portion 54 of the trough sidewall 16 does not have the anti-spill lip. The distal portion 54 of the trough sidewall 16 is able to be slidingly received into the coupler 20 and engage with the central and outward catches 40A, 40B. Preferably, an upper edge 56 of the coupler sidewall 26 has an anti-spill lip 58 such that the feeder assembly 22 has a substantially continuous anti-spill lip 50, 58 along the combined length of the troughs 12 and coupler 20.

While the feeder of the present disclosure has been described to be a poultry feeder intended for use in chickens, it will be apparent to those skilled in the art that the feeder described herein may be used with all types of poultry, including other livestock, such as ducks and turkeys. As various changes could be made in the above constructions without departing from the broad scope of the invention, it is intended that all matter contained in the above description or shown in the accompanying drawings shall be interpreted as illustrative and not in a limiting sense.

1. A trough feeder system having a plurality of troughs that are arranged end to end, each trough having a base and a pair of sidewalls extending from the base so the trough forms a cupping shape such that the trough is able to contain a supply of feed, the trough feeder system having a plurality of couplers, each of the couplers configured to connect two adjacent troughs such that each of the troughs is prevented from rotating both horizontally and vertically relative to the trough to which it is joined with the coupler, wherein each coupler has a base and a pair of sidewalls such that the coupler has a cupping shape substantially corresponding to the shape of the troughs, wherein an end of the trough coupled by the coupler is slidingly inserted into one end of the coupler, each coupler comprising:
at least one sidewall stop protruding inwardly from one of the coupler sidewalls that limits the distance that the trough can be inserted longitudinally into the coupler, wherein the sidewall stop has a protruding lip that extends over a distal end of the sidewall of the inserted trough;
a lower stop protruding upwardly from the coupler base that limits distance that the trough can be inserted longitudinally into the coupler;
a plurality of upper catches protruding inwardly from at least one of the coupler sidewalls, the plurality of catches comprising a central catch generally above the sidewall stop and a pair of outward catches, one close to the each end of the coupler, wherein the central catch and one of the outward catches capture each trough at different positions along the longitudinal axis of the trough so as to prevents the trough from rotating relative to the coupler and also the adjacent trough being held by the coupler.

2. The trough feeder system of claim 1 wherein the stop has protruding lips in both directions such that the stop acts as a catch for both of the troughs being joined by the coupler.

3. The trough feeder system of claim 1 wherein the central catch extends longitudinally on each side of the sidewall stop such that when two troughs are inserted into the coupler such that distal ends of the troughs contact opposing sides of the stop, an upper edge of each trough sidewall is captured by the central catch.

4. The trough feeder system of claim 1 wherein each sidewall of the coupler has the central catch and outward catches.

5. The trough feeder system of claim 1 wherein upper edges of the trough sidewall have an anti-spill lip at least partially along the longitudinal length of the trough, wherein the anti-spill lip is formed on the upper edge of the trough sidewall in a middle portion of the trough but a distal portion of the trough sidewall does not have the anti-spill lip such that the distal portion of the trough sidewall is able to be slidingly inserted into the coupler and engage with the central and outward catches, and wherein an upper edge of the coupler sidewall has an anti-spill lip such that the anti-spill lip on the trough and the anti-spill lip on the coupler form a continuous lip along the combined length of the troughs and coupler.
